(19) United States
(12) Patent Application Publication
(10) Pub. No.: US 2026/0205812 A1
(43) Pub. Date: Jul. 16, 2026

(54) MODULATION-ENHANCED AUTHENTICATION

(71) Applicant: Nokia Technologies Oy, Espoo (FI)

(72) Inventors: Aki HEKKALA, Oulu (FI); Matti PIKKARAINEN, Oulu (FI); Hannes NURMINEN, Tampere (FI)

(21) Appl. No.: 19/135,115

(22) PCT Filed: Oct. 30, 2023
(86) PCT No.: PCT/EP2023/080177

§ 371 Date: Jun. 3, 2025

(30) Foreign Application Priority Data
Dec. 12, 2022 (FI) 20226097

(51) Int. Cl. H04W 12/069

(52) U.S. Cl. CPC H04W 12/069

(57) ABSTRACT

A method including generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmitting the modulation symbol.

### FIELD

The following example embodiments relate to wireless communication.

### BACKGROUND

In wireless communication, a hostile user (“spoofer”) may listen to the communication, change a non-secured signal, and re-transmit it as if it were coming from the original transmitter. It is desirable to improve the security of wireless communication in order to make spoofing or similar eavesdropper attacks more difficult.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: generate a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmit the modulation symbol.

According to another aspect, there is provided an apparatus comprising: means for generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and means for transmitting the modulation symbol.

According to another aspect, there is provided a method comprising: generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmitting the modulation symbol.

According to another aspect, there is provided a computer program comprising instructions which, when executed by an apparatus, cause the apparatus to perform at least the following: generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmitting the modulation symbol.

According to another aspect, there is provided a computer readable medium comprising program instructions which, when executed by an apparatus, cause the apparatus to perform at least the following: generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmitting the modulation symbol.

According to another aspect, there is provided a non-transitory computer readable medium comprising program instructions which, when executed by an apparatus, cause the apparatus to perform at least the following: generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and transmitting the modulation symbol.

According to another aspect, there is provided an apparatus comprising at least one processor, and at least one memory storing instructions that, when executed by the at least one processor, cause the apparatus at least to: receive a modulation symbol from a transmitter; compare the modulation symbol at least with an expected modulation symbol, wherein the expected modulation symbol is based on a pre-defined key; and authenticate the transmitter based at least partly on the comparison.

According to another aspect, there is provided an apparatus comprising: means for receiving a modulation symbol from a transmitter; means for comparing the modulation symbol at least with an expected modulation symbol, wherein the expected modulation symbol is based on a pre-defined key; and means for authenticating the transmitter based at least partly on the comparison.

According to another aspect, there is provided a method comprising: receiving a modulation symbol from a transmitter; comparing the modulation symbol at least with an expected modulation symbol, wherein the expected modulation symbol is based on a pre-defined key; and authenticating the transmitter based at least partly on the comparison.

According to another aspect, there is provided a computer program comprising instructions which, when executed by an apparatus, cause the apparatus to perform at least the following: receiving a modulation symbol from a transmitter; comparing the modulation symbol at least with an expected modulation symbol, wherein the expected modulation symbol is based on a pre-defined key; and authenticating the transmitter based at least partly on the comparison.

According to another aspect, there is provided a computer readable medium comprising program instructions which, when executed by an apparatus, cause the apparatus to perform at least the following: receiving a modulation symbol from a transmitter; comparing the modulation symbol at least with an expected modulation symbol, wherein the expected modulation symbol is based on a pre-defined key; and authenticating the transmitter based at least partly on the comparison.

According to another aspect, there is provided a non-transitory computer readable medium comprising program instructions which, when executed by an apparatus, cause the apparatus to perform at least the following: receiving a modulation symbol from a transmitter; comparing the modulation symbol at least with an expected modulation symbol, wherein the expected modulation symbol is based on a pre-defined key; and authenticating the transmitter based at least partly on the comparison.

### LIST OF DRAWINGS

In the following, various example embodiments will be described in greater detail with reference to the accompanying drawings, in which

FIG. 1 illustrates an example of a cellular communication network;

FIG. 2 illustrates an example of a modulation constellation;

FIG. 3A illustrates an example of a modulator;

FIG. 3B illustrates an example of a first modulator and a second modulator;

FIG. 3C illustrates an example of a modulation constellation with Gray labelling;

FIG. 4 illustrates a signaling diagram;

FIG. 5 illustrates a flow chart;

FIG. 6 illustrates a flow chart;

FIG. 7 illustrates a flow chart;

FIG. 8 illustrates an example of an apparatus; and

FIG. 9 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

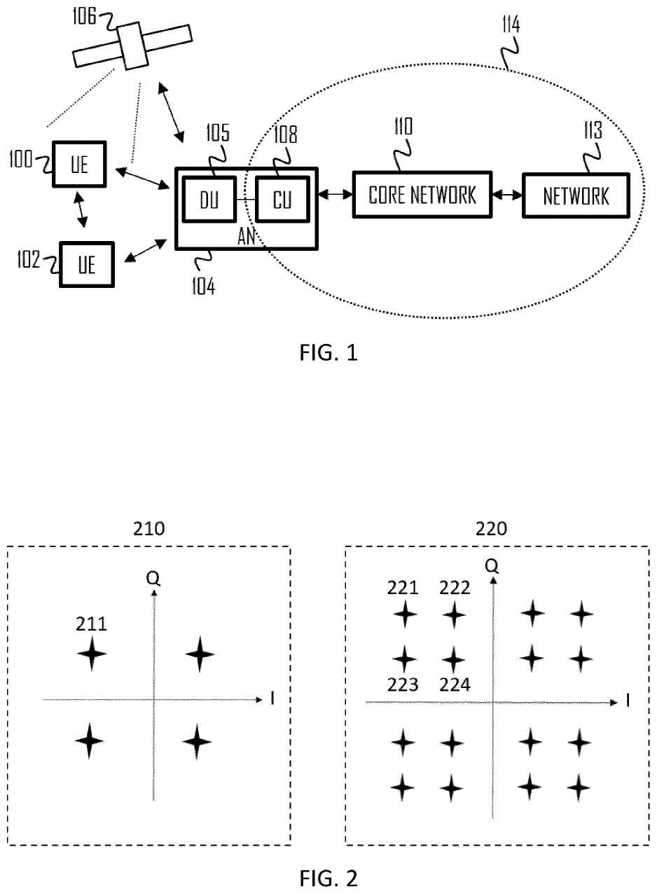

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

When two or more UEs, or a base station and a UE, are communicating with each other, they may need to check whether the other party of the messaging is trusted or not. There are cases where spoofing or impersonation may happen, and the target, for example a UE or a base station or multiple units, would receive messages with modified or fake information.

For example, two or more UEs may transmit reference signals between each other, but neither of them may be authenticated (e.g., by a base station). A problem appears when a hostile user (“spoofer”) listens to the communication, changes a non-secured signal and re-transmits it as if it were coming from the original transmitter.

Generally, for any kind of signaling where the integrity of the communication is an issue, it may be beneficial to add an additional layer of security. Physical layer security offers some advantages, such as time dependency. The time dependency means that the signal flow (e.g., in 5G NR) is dependent on the slot and symbol number, and whenever the received slot and/or symbol numbers do not match, the receiver may abandon the received message.

A reference signal is typically for specific purposes in a wireless system, e.g., for channel acquisition, positioning, delay estimation, channel estimation, etc. Physical layer security has traditionally focused on improving the security or integrity of generic data, while here we consider specific embodiments involving a reference signal.

A reference signal, such as a positioning reference signal (PRS) or a sounding reference signal (SRS), may not contain any encryption in itself. For example, a PRS or an SRS may be formed based on pseudo-random sequences, such as a Zadoff-Chu sequence. The reference signals may not use the same physical channel, such as a physical downlink shared channel (PDSCH), but the PDSCH may be used to configure them (e.g., PRS) in the presence of a base station. Therefore, the reference signal itself is not encrypted, but the information needed to recognize it may be encrypted. This information may be transmitted in the configuration message using PDSCH. In other words, when in connected mode (i.e., when the base station link to UE is established), the reference signals may be secured through the configuration over PDSCH.

Thus, if a spoofer gets to know the cell identity and/or the slot and symbol numbers, the spoofer may be able to read, modify and re-transmit the reference signal (e.g., PRS or SRS) to the target. The cell identity may be used in the seed for the symbol generator, and the slot and symbol numbers may be part of the configuration message and varying along the time, thus needed to demodulate the reference signal.

In sidelink communication (i.e., direct device-to-device communication between two or more UEs), the encryption as described above for the base station may not be valid, as the sidelink communication may not be authenticated in the same way. In sidelink communication, the need for the authentication may be an issue for the same reasons as described above for the base station case. The target UE (receiver UE) should know how to authenticate the transmitter UE, i.e., how to authenticate the messages transmitted by the transmitter UE.

UEs may utilize one of the following resource allocation modes for sidelink: NR sidelink mode 1 (network-controlled mode), or NR sidelink mode 2 (UE-autonomous mode). In NR sidelink mode 1, the network (e.g., base station) allocates the sidelink resources for UEs. In NR sidelink mode 2, UEs autonomously select sidelink resources based on a sensing mechanism. For NR sidelink mode 1, the UE may need to be in the RRC_CONNECTED state, i.e., in the network coverage. NR sidelink mode 2 may be applied when the UE is out of network coverage (e.g., when the UE is in RRC_INACTIVE or RRC_IDLE state).

Currently, there is no standardized method to authenticate the parties of the messaging in sidelink communication, when the sidelink is not configured by the base station. Thus, a new mechanism for authentication may be needed, for example for the out-of-coverage case (i.e., when the UEs are outside the network coverage).

Some example embodiments are described below using principles and terminology of 5G technology without limiting the example embodiments to 5G communication systems, however.

Some example embodiments relate to the authentication of a transmitter. The authentication in this context means that the identity of the transmitter is verified (at least up to a certain level of confidence). The authentication may be beneficial in a hostile environment where the transmission could be impersonated, which would lead to false detection and interpretation of the reference signal.

As an example, a malicious attack on a PRS could change the signal in such a way that the target fails to identify the location falling in an incident. For example, PRS may be used in autonomous driving to locate the vehicle position. In traffic, the falling in an incident may mean, for example, a collision to an object on the road (e.g., other car, pillar, etc.) that is not on the lane, i.e., the car cannot keep the right lane. In a more complex scenario, it may also be an object on the lane that should not be there (for the normal traffic), but for any reason it is there and the system detects it and notifies the car. However, because of the attack and thus failed location information, the braking system may not operate. It should be noted that this is just one example, and some example embodiments may also be used for other applications than traffic.

Some example embodiments provide a method to run the authentication embedding a secret key in the reference signal (physical layer signal), while still using the reference signal definition. There may be at least two options to increase the modulation order and to add the authentication: 1) build a mapping between the modulations, transform the signal to the higher order modulation according to the mapping rules, and apply the authentication key by using a perturbation technique, or 2) add the authentication bits to the signal (i.e., arriving directly to the higher order modulation). The mapping may also be referred to as labelling herein.

The method can be applied to any reference signal, when it is desirable to increase the integrity of the reference signal. Herein the integrity refers to positioning integrity, which is a measure of the trust in the accuracy of the position-related data provided by the positioning system and the ability to provide timely and valid warnings to the location service (LCS) client, when the positioning system does not fulfil the condition for intended operation.

Some example embodiments may be applied to any non-encrypted reference signal, such as PRS or SRS for positioning, which are currently not secured in the sidelink mode. The sidelink means that there are two or more UEs having communication between each other, either without being configured by a base station, or configured fully or partially by a base station. Note that, ‘sidelink’ may be referred to as, for example, ‘device-to-device’ communications in other standards or in other wireless systems.

In addition to sidelink communication, some example embodiments may also be applied, for example, to downlink communication, uplink communication, Wifi or Bluetooth.

Some example embodiments may also be applied to the case, where the encryption is applied or is possible, but for any reason an additional layer of security is desired.

It should be noted that some example embodiments are not limited to PRS or SRS for positioning, and they may also be applied to any other reference signal, such as a phase-tracking reference signal (PTRS) or a channel state information reference signal (CSI-RS). Herein the PRS may refer to downlink PRS. SRS for positioning may be an uplink reference signal or a sidelink reference signal.

In an example embodiment, the modulation order of the reference signal may be increased at least one level in the number of symbol allocations in the in-phase/quadrature (I/Q) space. Increasing the modulation order may mean, for example, using 16QAM modulation instead of QPSK for the reference signal. QAM is an abbreviation for quadrature amplitude modulation, and QPSK is an abbreviation for quadrature phase shift keying. 16QAM is a quadrature amplitude modulation based on a constellation of 16 symbols.

However, some example embodiments are not limited to QPSK and 16QAM, and higher or lower order modulations may also be used. Therefore, similar increase of modulation order can be done by e.g. if the reference signal is 16QAM and the increased modulation is 32QAM or 64QAM, for example. In principle, if a PRS symbol is QPSK (two bits mapped to a symbol constellation with a particular labelling), the increased modulation order can be constructed by multiplexing additional N bits (2\hat{ }N possible states for each QPSK constellation point) according to a particular ‘key’. Then the end result is a signal with 2\hat{ }(N+2) states. Moreover, the number of states may not need to be increased in powers of two, if, for example, the same additional bits apply to two different symbols, or e.g. only to some of the PRS symbols in a sequence of PRS symbols. The increased constellation or modulation order may be carried out either at bit-level (increasing the bit rate, keeping symbol rate fixed, for example) or at symbol-level (e.g., summing to symbols each with fixed symbol rate, for example). In the former case, the bit labelling can be done so as to achieve the desired technical purpose. For example, bit labelling can be changed for at least one symbol in a sequence of symbols according to a ‘key’ unknown to a potential spoofer.

For example, the actual reference signal (which is modulated into the higher level of modulation) may be “perturbated” according to the secret key. The perturbation makes a pattern over the modulation constellation in time. Because of the perturbation, the existing signals (including pilots) can be used, and therefore the function(s) of the pilot(s) are preserved. This time-domain pattern is read by the receiver (e.g., UE), and if it matches with the secret key, the transmitter is authenticated. At the same time, the actual reference signal may also be read while coded into the 16QAM modulation. If necessary, it can be reduced back to QPSK before the demodulation and other functions in the receiver.

The advantage of time-domain processing or implicit processing time constraints for authentication purposes comes from the physical layer implementation, because it makes it more difficult for a spoofer to read and re-transmit the (modified) signal within some required delay. The higher the (spoofer-induced) delay, the more likely it is for the intended receiver to detect that the signal is spoofed, and thereby, for example, to make the decision not to use the received signal. If the receiver receives an excessively delayed signal, then the receiver may choose to ignore this signal, since there is a possibility that the signal has been modified and re-transmitted by a spoofer. The physical layer has less processing-related delay, so the time-domain (constraint) can be made more stringent. For example, the radio channel itself may be very fast in comparison to any hostile signal processing, and the delay spread may be short (e.g., 10-100 ns). Thus, if the signal arrives at the receiver later than this, then the receiver may ignore the signal. As a consequence, the actual encryption may not need to be that strong, as long as there is confidence that the decryption of the signal by the spoofer requires a sufficiently large amount of time.

FIG. 2 illustrates an example of a QPSK modulation constellation 210, and an example of a 16QAM modulation constellation 220. In FIG. 2, a given “star” 211, 221, 222, 223, 224 illustrates a modulation symbol. A modulation symbol may also be referred to as a constellation point herein. Digital data may be sent using different symbols, which correspond to different bits. QPSK may have 4 symbols and use 2 bits per symbol (i.e., a given symbol of the 4 symbols may be defined using 2 bits). 16QAM may have 16 symbols and use 4 bits per symbol, wherein the first 2 bits may define the quadrant and the last 2 bits may define the 16QAM coding of a given symbol. Increasing the modulation order enables to embed additional bits into the signal for authentication purposes, but it may also reduce the resistance to errors, since the symbols are closer to each other, depending on power allocation, for example.

In an example case, UEs (e.g., UEs embedded in cars) may initially be in coverage of a base station (e.g., gNB), and the UEs may be authenticated by the base station. The UEs may communicate with each other (e.g., using a sidelink configuration) in order to control the distance between the cars, i.e., to continue non-collision traffic. The UEs may be approaching an area, where the network coverage is weak or non-present (e.g., a tunnel where no repeater is installed). Thus, the base station informs the UEs (cars) that other nearby UEs (cars) are authenticated. The cars then enter the tunnel.

In the tunnel, the UEs may be out-of-coverage of the network. However, the base station may have shared a key for the authenticated UEs before the cars drive outside of the in-coverage area. The key in this case may be local and time varied. In the tunnel, the autonomous driving, i.e., collision control, may be managed by the sidelink communication. The key may be used to prevent a hostile spoofer from disinforming the UEs and to avoid falling in an incident.

As an example, the key may be a sequence of 2-digit binary codes (e.g., 00, 01, 11, 10), when using the QPSK to 16QAM transformation. These 2-digit codes may be for the same quadrant of the constellation diagram. If a higher order modulation is used, additional bits may be used. The more there are bits, the higher is the complexity to find out the pattern.

Referring to FIG. 2, the perturbation may mean to run the transformation, for example, first from the upper-left quadrant of block 210 to a constellation point in the upper-left quadrant of block 220 (and respectively the other quadrants), and to apply a perturbation according to the key for example as follows: code 00 does not move the constellation point, code 10 moves (rotates) the constellation point once in the clockwise direction in the quadrant (e.g., from point 221 to point 222), code 11 moves the constellation point two steps clockwise (e.g., from point 221 to point 224), and 01 moves the constellation point once counter-clockwise (e.g., from point 221 to point 223). However, it should be noted that this is just one example, and other perturbation methods and their combinations may also be possible. Furthermore, the base station may change the code definition on-the-fly. For example, in the next time instance, the base station may define that code 00 means to move the symbol twice in the clockwise direction, and so on.

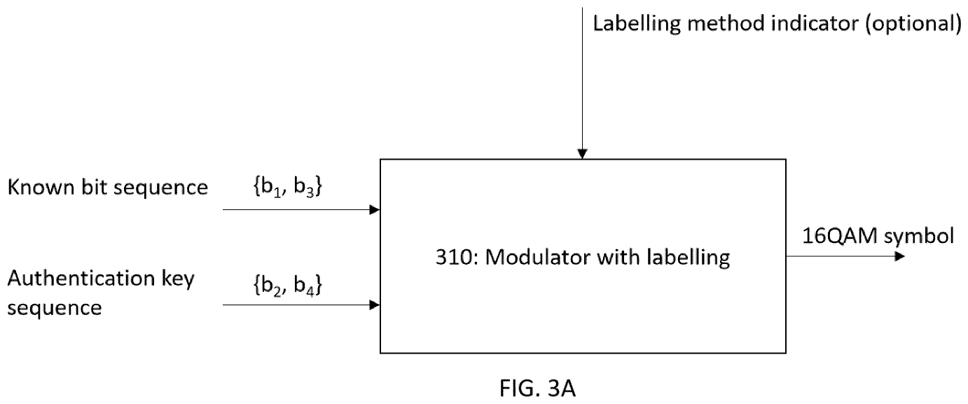

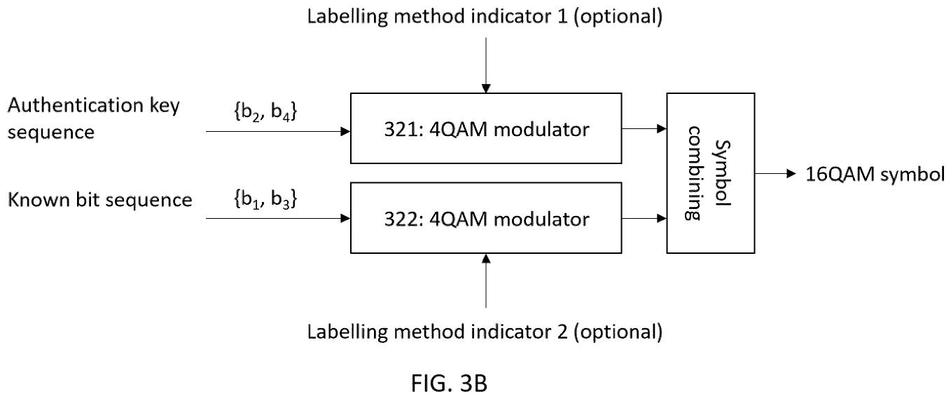

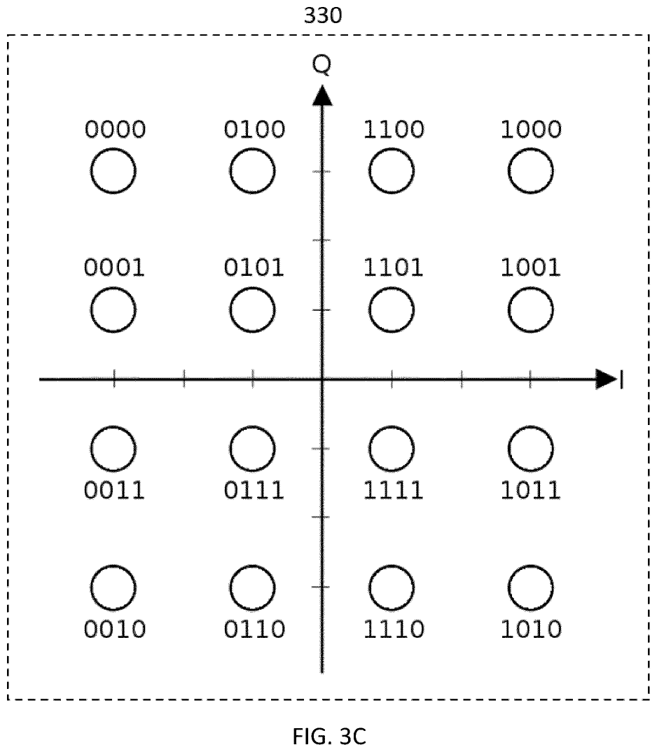

FIG. 3A illustrates an example of a modulator 310 that may be used by a transmitter in an example embodiment. A bit stream comprising a known bit sequence and an authentication key sequence may be fed into the modulator 310 to generate the modulated symbol (e.g., 16QAM symbol). The known sequence may be, for example, a Zadoff-Chu sequence, a PRS sequence, or an SRS sequence. The authentication key sequence may be provided or pre-defined by the network. The association of the symbols and the bits may be provided by labelling, for example Gray labelling. The labelling may be optionally changed for another symbol, or for another sequence of symbols. In one embodiment, for example, another 16QAM symbol may apply another labelling preferably agreed by the transmitter and the receiver (but generally unknown to a spoofer), where the labels are mirrored with respect to the I-axis (so that, for example, labels 0010 and 0000 are interchanged, and similarly for 0100, 0110 and for 0001 and 0011, and so on). It is clear that there are other ways to determine labels (e.g., mirroring about Q-axis, and so on). Moreover, one symbol may have Gray labelling while the next may not. Moreover, the authentication key sequence may have one or more bits per 16QAM symbol, although in the above example two bits are used (per symbol). If only one authentication bit is used per symbol, the resulting constellation would be 8QAM as opposed to 16QAM, as is clear to a person skilled in the art.

It may be beneficial to apply the labelling such that the perturbed symbol (e.g., 16QAM symbol) is in the same quadrant of the modulation constellation as the original symbol (e.g., QPSK symbol). This way, the authentication scheme may be backwards compatible, i.e., a receiver that does not support the authentication can still use the reference signal. Furthermore, by keeping the symbol in the same quadrant, the reference signal maintains its orthogonal properties with other reference signal sources.

FIG. 3B illustrates an example of a first modulator 321 and a second modulator 322 that may be used by a transmitter in another example embodiment. An authentication key sequence may be fed into the first modulator 321, and a known bit sequence may be fed into the second modulator 322. The known sequence may be, for example, a Zadoff-Chu sequence, a PRS sequence, or an SRS sequence. The authentication key sequence may be provided or pre-defined by the network. The first modulator 321 may generate a first symbol (e.g., a first 4QAM symbol), and the second modulator 322 may generate a second symbol (e.g., a second 4QAM symbol). The first symbol and the second symbol may then be combined to generate a symbol with a higher order modulation (e.g., a 16QAM symbol). Similar use of labelling, or change of labelling and indication thereof) as above can be used in this embodiment, applied to 4QAM symbols.

FIG. 3C illustrates an example of a constellation diagram 330 for Gray-coded 16QAM. In 16QAM, a given symbol may be defined by four bits, as shown in FIG. 3C. b₁ denotes the first bit, b₂ denotes the second bit, b₃ denotes the third bit, and b₄ denotes the fourth bit. The symbol may be in the upper-left quadrant of the constellation, if the first and third bit are both zero (b₁=0, b₃=0). The symbol may be in the lower-left quadrant of the constellation, if the first bit is zero and the third bit is one (b₁=0, b₃=1). The symbol may be in the upper-right quadrant of the constellation, if the first bit is one and the third bit is zero (b₁=1, b₃=0). The symbol may be in the lower-right quadrant of the constellation, if the first bit is one and the third bit is one (b₁=1, b₃=1).

In an example embodiment, as discussed above, the labelling may be changed (e.g., from that shown in FIG. 3C), such that the authentication key sequence changes the bit definition for a given 16QAM symbol. For example, the symbols may be rotated according to the key sequence. As another example, the labels may be changed for all the bits. As another example, the labels may be changed just for odd or even bits. For example, the odd bits and the even bits may swap labels, so that an eavesdropper is not aware of it. The specific labelling method may be pre-defined or indicated by the network. However, it should be noted that all the labellings (or codings) presented herein are just examples, and it should be understood that other (e.g., more complicated) labellings may also be possible.

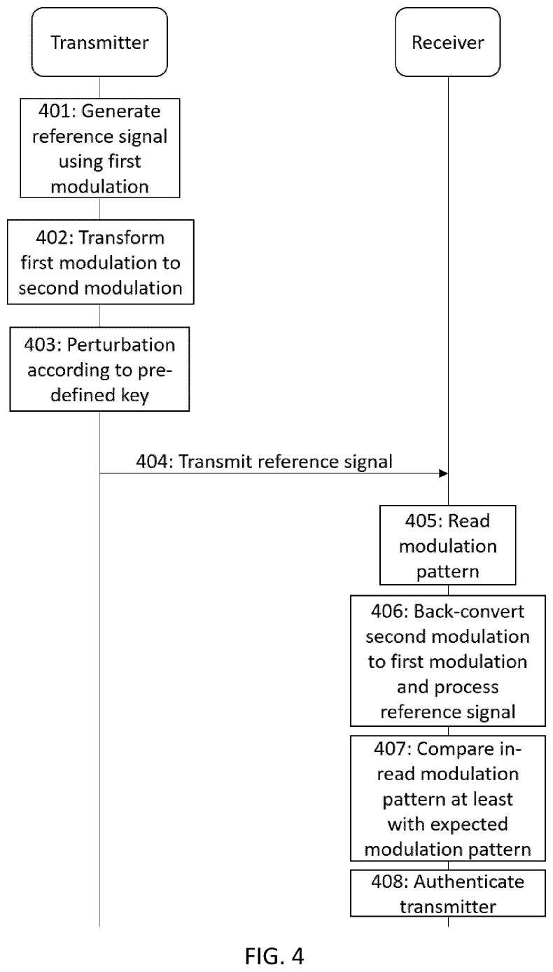

FIG. 4 illustrates a signaling diagram according to an example embodiment.

Referring to FIG. 4, in block 401, a transmitter generates a reference signal using a first modulation. The transmitter may be, for example, a UE or a network node (e.g., a base station) of a wireless communication network.

In block 402, the modulation scheme of the reference signal is changed. In other words, the first modulation is transformed to a second modulation, wherein the second modulation comprises a higher modulation order than the first modulation. For example, the first modulation may comprise QPSK, and the second modulation may comprise 16QAM.

The reference signal itself may be created from the seed and the polynomial as defined in 3GPP standards. Thus, no changes are needed in the creation of the reference signal. However, the reference signal may be presented in the 16QAM constellation.

In block 403, a secret key may be embedded into the reference signal by a perturbation technique. The perturbation here means to modify or change the modulation pattern of the second modulation in the reference signal in a pre-defined way, i.e., based on a pre-defined key. Herein the modulation pattern may mean the pattern of constellation points (symbols), for example as shown in FIG. 2. This pattern may be applied to consecutive symbols in modulation domain. While the reference signal may be generated in QPSK domain, the modulation level, or complexity, may be increased by at least one level to get some distance (“error distance”) between the actual modulation constellation points, and thus to intentionally create some EVM. As an alternative to a two-dimensional pattern, the key could also comprise other domains to change the modulation constellation, such as nulling, power change, time domain delay, and maybe also frequency shifting (however, to be applied then at different phases of the transmission reception operation).

There may be a 1:1 mapping between the different levels of modulations. For example, this means that for every QPSK constellation point there may be unambiguously a respective point in 16QAM, and similarly for all higher order modulations. In other words, while the actual signal may be generated into QPSK domain, a mapping from QPSK to the next supported higher-order modulation may be created. Herein 16QAM is used as an example of the higher-order modulation (QPSK uses 2 bits per symbol, while 16QAM uses 4 bits per symbol). Thus, for every QPSK constellation point, there are 4 potential 16QAM points that the QPSK constellation point may correspond to. However, the mapping should be unique and therefore just one of the 4 points of 16QAM is correct (in other words, is defined to be correct). The other 3 points have certain error distances in the sense of error vector magnitude (EVM). These error distances are also unique and, therefore, there are four possible perturbations for a constellation point.

Applying sequentially the perturbations there are four options for every constellation point: 1) no change, 2) change in in-phase (I) direction, 3) change in quadrature (Q) direction, or 4) change in both I and Q directions. In other words, the transmitter may modify the modulation pattern by moving one or more modulation symbols of the modulation pattern in an in-phase direction, or in a quadrature direction, or in both the in-phase direction and the quadrature direction based on the pre-defined key.

Including the option “no change” may increase the computational complexity for the spoofer, since there are four options to analyze instead of three. Thus, not every symbol needs to be perturbed, but the key indicates whether to apply the perturbation to a given symbol.

It may be beneficial to apply the perturbation such that the average transmission power of the reference signal is not changed relative to the original (non-perturbed) reference signal.

In block 404, the transmitter transmits the reference signal to a receiver using the second modulation (e.g., 16QAM) and the modified (perturbed) modulation pattern. The receiver receives the reference signal. The receiver may be, for example, another UE or a network node (e.g., a base station) of a wireless communication network.

In case of downlink communication, the transmitter may be a base station, and the receiver may be a UE. In case of uplink communication, the transmitter may be a UE, and the receiver may be a base station. In case of sidelink communication, the transmitter may be a UE, and the receiver may be another UE.

It should be noted that, in case of reference signals, the receiver knows the signal a-priori, and thus the “correct” and “perturbed” signals can be distinguished from each other. In case of other signals than reference signals, any technique to pass the correct signal may be used.

In block 405, the receiver reads in the modulation pattern of the reference signal.

In block 406, the receiver may back-convert the second modulation to the first modulation (e.g., 16QAM modulation to QPSK) and process the reference signal based on the first modulation. However, the back-converting may be optional. The information of the reference signal is there also at higher level of modulation after the secret key demodulation, and thus the receiver may read the reference signal, while the reference signal is coded into the second modulation. In block 407, the receiver compares the in-read (e.g., 16QAM) modulation pattern at least with an expected modulation pattern, wherein the expected modulation pattern is based on the pre-defined key. In other words, the expected modulation pattern may correspond to the expected reference signal with perturbation. The pre-defined key may be known at the transmitter and at the receiver, but it may not be known by other parties. For example, the key may be pre-defined by the network for the transmitter and the receiver. The comparison can be done in different ways, for example with EVM metrics. The EVM metrics uses the concept of EVM in defining the distance of the received constellation point (symbol) to the pre-defined, supposed constellation point (symbol).

Modulation quality may be defined by the difference between the measured carrier signal and an ideal signal. Modulation quality may, for example, be expressed as EVM. The EVM is a measure of the difference between the ideal symbols and the measured symbols after the equalization. This difference is called the error vector.

Thus, every received constellation point (symbol) may be compared against a threshold value. Alternatively, the error may be within a range of two values, in the sense of the error vector. If the error of a given constellation point (symbol) is smaller than the pre-defined threshold value, the perturbation location is found and the process may move to the next constellation point.

Block 406 and block 407 may be parallel signal processing steps.

In block 408, the receiver authenticates the transmitter based on the comparison.

One option to authenticate the transmitter may be to compare the received reference signal to a local reference #1 (e.g., reference signal with expected perturbation) created in the receiver and to a local reference #2 (e.g., reference signal only) created in the receiver. The authentication may be considered to be successful, if the local reference #1 provides better correlation with the received signal than the local reference #2. A threshold value may optionally be used in the comparison, for example if the application requires a higher trust level on authentication. In this case, it would not be enough that the correlation of local reference #1 is just better than the local reference #2, but it should be better by a certain additional margin as indicated by the threshold value.

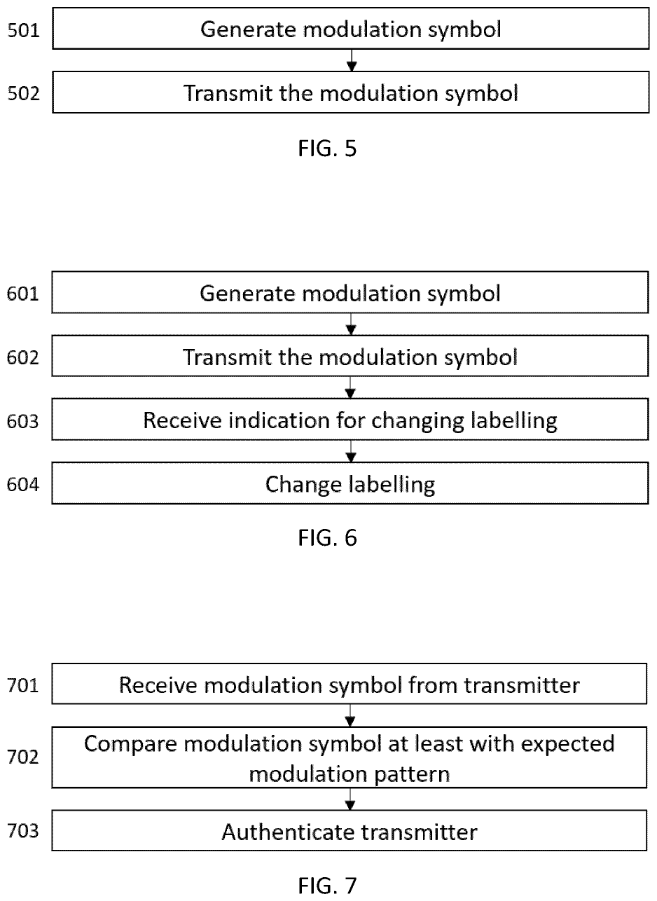

FIG. 5 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, user equipment (UE), or a transmitter UE. The user device may correspond to the UE 100 of FIG. 1, or the transmitter of FIG. 4.

As another example, the apparatus may be, or comprise, or be comprised in, a network node of a wireless communication network. The network node may correspond to the access node 104 of FIG. 1, or the transmitter of FIG. 4.

Referring to FIG. 5, in block 501, a modulation symbol is generated based on at least two bit sequences (see the example of FIG. 3A) or at least two symbol sequences (see the example of FIG. 3B), wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key.

For example, the modulation symbol may be part of the reference signal of FIG. 4.

The at least two bit sequences refer to at least two different bit sequences, wherein a given bit sequence may comprise one or more bits. Similarly, the at least two symbol sequences refer to at least two different symbol sequences, wherein a given symbol sequence may comprise one or more symbols.

For example, the modulation symbol may be generated by providing the at least two bit sequences to at least one modulator, and applying a labelling for associating the modulation symbol with the at least two bit sequences. An example of this is described above with reference to FIG. 3A.

The reference bit sequence or the reference symbol sequence may be associated with at least one of the following: a Zadoff-Chu sequence, a positioning reference signal, or a sounding reference signal.

The pre-defined key may be associated authentication information. The pre-defined key may be known by an intended receiver of the modulation symbol.

In block 502, the modulation symbol is transmitted.

FIG. 6 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, user equipment (UE), or a transmitter UE. The user device may correspond to the UE 100 of FIG. 1, or the transmitter of FIG. 4.

As another example, the apparatus may be, or comprise, or be comprised in, a network node of a wireless communication network. The network node may correspond to the access node 104 of FIG. 1, or the transmitter of FIG. 4.

Referring to FIG. 6, in block 601, a modulation symbol is generated based on at least two bit sequences (see the example of FIG. 3A), wherein at least one sequence of the at least two bit sequences is associated with a reference bit sequence or a reference symbol sequence, and at least one other sequence of the at least two bit sequences is associated with a pre-defined key. The modulation symbol may be generated by providing the at least two bit sequences to at least one modulator, and applying a labelling for associating the modulation symbol with the at least two bit sequences.

The reference bit sequence or the reference symbol sequence may be associated with at least one of the following: a Zadoff-Chu sequence, a positioning reference signal, or a sounding reference signal.

The pre-defined key may be associated with authentication information. The pre-defined key may be known by an intended receiver of the modulation symbol.

In block 602, the modulation symbol is transmitted.

In block 603, an indication is received from a network node, wherein the indication indicates to change the labelling.

In block 604, the labelling is changed, based on the indication received from the network node, for at least one of the following: the at least one modulator, or at least one other transmitted modulation symbol. The at least one other transmitted modulation symbol may be transmitted after receiving the indication and changing the labelling. The labelling may be changed in a manner known by an intended receiver. For example, the receiver may also receive the indication from the network node.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 7 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, user equipment (UE), or a receiver UE. The user device may correspond to the UE 102 of FIG. 1, or the receiver of FIG. 4.

As another example, the apparatus may be, or comprise, or be comprised in, a network node of a radio access network. The network node may correspond to the access node 104 of FIG. 1, or the receiver of FIG. 4.

Referring to FIG. 7, in block 701, a modulation symbol is received from a transmitter. For example, the modulation symbol may be part of the reference signal of FIG. 4.

In block 702, the apparatus compares the modulation symbol at least with an expected modulation symbol, wherein the expected modulation symbol is based on a pre-defined key. For example, the comparison may be based on an error vector magnitude between the received modulation symbol and the expected modulation symbol associated with the pre-defined key.

In block 703, the transmitter is authenticated based at least partly on the comparison.

The blocks, related functions, and information exchanges (messages) described above by means of FIGS. 4-7 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

A technical advantage provided by some example embodiments is that they may improve the security of wireless communication. For example, an eavesdropper monitoring reference signals cannot utilize said signals as well as the intended receiver, since without knowing the key, the eavesdropper sees a more noisy signal (or a completely different signal), and it is more difficult for the eavesdropper to authenticate/crack the signal in limited time. The time is a factor to play against the spoofer, because if the signal comes too late, the transmitter may decide not to use it because of risk of hostile manipulation.

Furthermore, some example embodiments may not require any additional bandwidth, since no additional bits may be presented. Thus, some example embodiments require no new functions to be implemented on the hardware level for creating the different modulations.

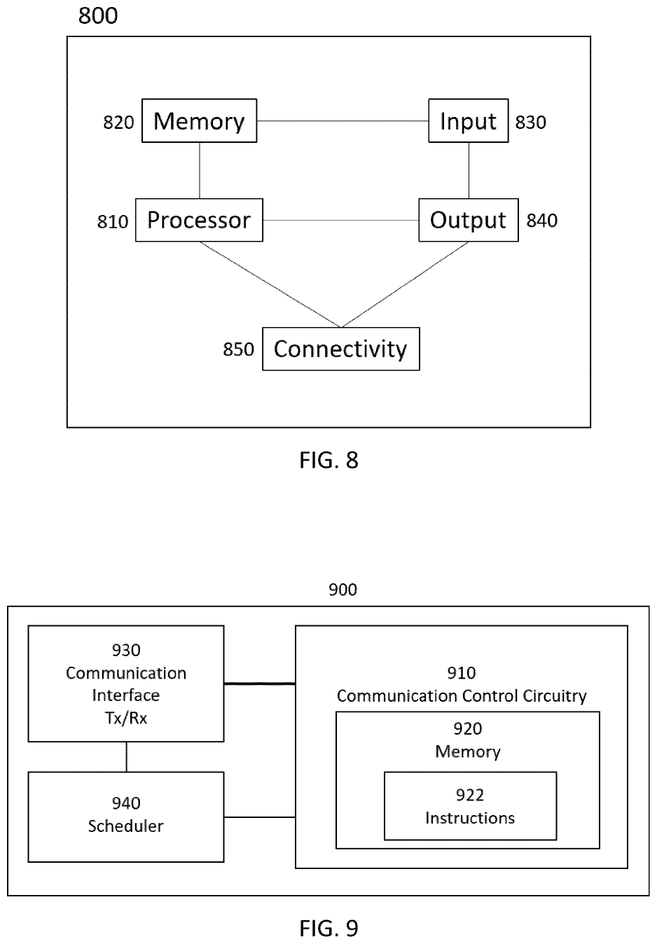

FIG. 8 illustrates an example of an apparatus 800 comprising means for performing one or more of the example embodiments described above. For example, the apparatus 800 may be an apparatus such as, or comprising, or comprised in, a user device. The user device may correspond to one of the user devices 100, 102 of FIG. 1, or the transmitter or receiver of FIG. 4. The user device may also be called a subscriber unit, mobile station, remote terminal, access terminal, user terminal, terminal device, or user equipment (UE).

The apparatus 800 may comprise a circuitry or a chipset applicable for realizing one or more of the example embodiments described above. For example, the apparatus 800 may comprise at least one processor 810. The at least one processor 810 interprets instructions (e.g., computer program instructions) and processes data. The at least one processor 810 may comprise one or more programmable processors. The at least one processor 810 may comprise programmable hardware with embedded firmware and may, alternatively or additionally, comprise one or more application-specific integrated circuits (ASICs).

The at least one processor 810 is coupled to at least one memory 820. The at least one processor is configured to read and write data to and from the at least one memory 820. The at least one memory 820 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 820 stores computer readable instructions that are executed by the at least one processor 810 to perform one or more of the example embodiments described above. For example, non-volatile memory stores the computer readable instructions, and the at least one processor 810 executes the instructions using volatile memory for temporary storage of data and/or instructions. The computer readable instructions may refer to computer program code.

The computer readable instructions may have been pre-stored to the at least one memory 820 or, alternatively or additionally, they may be received, by the apparatus, via an electromagnetic carrier signal and/or may be copied from a physical entity such as a computer program product. Execution of the computer readable instructions by the at least one processor 810 causes the apparatus 800 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 800 may further comprise, or be connected to, an input unit 830. The input unit 830 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 830 may comprise an interface to which external devices may connect to.

The apparatus 800 may also comprise an output unit 840. The output unit may comprise or be connected to one or more displays capable of rendering visual content, such as a light emitting diode (LED) display, a liquid crystal display (LCD) and/or a liquid crystal on silicon (LCoS) display. The output unit 840 may further comprise one or more audio outputs. The one or more audio outputs may be for example loudspeakers.

The apparatus 800 further comprises a connectivity unit 850. The connectivity unit 850 enables wireless connectivity to one or more external devices. The connectivity unit 850 comprises at least one transmitter and at least one receiver that may be integrated to the apparatus 800 or that the apparatus 800 may be connected to. The at least one transmitter comprises at least one transmission antenna, and the at least one receiver comprises at least one receiving antenna. The connectivity unit 850 may comprise an integrated circuit or a set of integrated circuits that provide the wireless communication capability for the apparatus 800. Alternatively, the wireless connectivity may be a hardwired application-specific integrated circuit (ASIC). The connectivity unit 850 may also provide means for performing at least some of the blocks of one or more example embodiments described above. The connectivity unit 850 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 800 may further comprise various components not illustrated in FIG. 8. The various components may be hardware components and/or software components.

FIG. 9 illustrates an example of an apparatus 900 comprising means for performing one or more of the example embodiments described above. For example, the apparatus 900 may be an apparatus such as, or comprising, or comprised in, a network node of a radio access network. The network node may correspond to the access node 104 of FIG. 1, or the receiver of FIG. 4. The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 900 may comprise, for example, a circuitry or a chipset applicable for realizing one or more of the example embodiments described above. The apparatus 900 may be an electronic device comprising one or more electronic circuitries. The apparatus 900 may comprise a communication control circuitry 910 such as at least one processor, and at least one memory 920 storing instructions 922 which, when executed by the at least one processor, cause the apparatus 900 to carry out one or more of the example embodiments described above. Such instructions 922 may, for example, include a computer program code (software), wherein the at least one memory and the computer program code (software) are configured, with the at least one processor, to cause the apparatus 900 to carry out one or more of the example embodiments described above. The at least one processor and the at least one memory storing the instructions may provide the means for providing or causing the performance of any of the methods and/or blocks described above.

The processor is coupled to the memory 920. The processor is configured to read and write data to and from the memory 920. The memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 920 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 900 may further comprise a communication interface 930 comprising hardware and/or software for realizing communication connectivity according to one or more communication protocols. The communication interface 930 comprises at least one transmitter (Tx) and at least one receiver (Rx) that may be integrated to the apparatus 900 or that the apparatus 900 may be connected to. The communication interface 930 may provide means for performing some of the blocks for one or more example embodiments described above. The communication interface 930 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 930 provides the apparatus with radio communication capabilities to communicate in the cellular communication system. The communication interface may, for example, provide a radio interface to one or more user devices. The apparatus 900 may further comprise another interface towards a core network such as the network coordinator apparatus or AMF, and/or to the access nodes of the cellular communication system.

The apparatus 900 may further comprise a scheduler 940 that is configured to allocate radio resources. The scheduler 940 may be configured along with the communication control circuitry 910 or it may be separately configured.

It is to be noted that the apparatus 900 may further comprise various components not illustrated in FIG. 9. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1-18. (canceled)

19. An apparatus comprising at least one processor, and at least one memory storing instructions that, when executed by the at least one processor, cause the apparatus at least to:
generate a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and
transmit the modulation symbol.

20. The apparatus according to claim 19, wherein the reference bit sequence or the reference symbol sequence is associated with at least one of the following: a Zadoff-Chu sequence, a positioning reference signal, or a sounding reference signal.

21. The apparatus according to claim 19, wherein the pre-defined key is associated with authentication information.

22. The apparatus according to claim 19, wherein the pre-defined key is known by an intended receiver of the modulation symbol.

23. The apparatus according to claim 19, wherein the modulation symbol is generated by providing the at least two bit sequences to at least one modulator, and applying a labelling for associating the modulation symbol with the at least two bit sequences.

24. The apparatus according to claim 19, further being caused to:
change, based on an indication received from a network node, the labelling for at least one of the following: the at least one modulator, or at least one other transmitted modulation symbol, wherein the labelling is changed in a manner known by an intended receiver.

25. The apparatus according to claim 19, further being caused to:
generate a reference signal using a first modulation, wherein the modulation symbol is part of the reference signal;
transform the first modulation of the reference signal to a second modulation, wherein the second modulation comprises a higher modulation order than the first modulation;
modify a modulation pattern of the second modulation in the reference signal based on the pre-defined key; and
transmit the reference signal using the second modulation and the modified modulation pattern.

26. The apparatus according to claim 19, wherein the modulation pattern is modified by moving one or more modulation symbols of the modulation pattern in an in-phase direction, or in a quadrature direction, or in both the in-phase direction and the quadrature direction based on the pre-defined key.

27. The apparatus according to claim 19, wherein the first modulation comprises quadrature phase shift keying, QPSK, and the second modulation comprises 16 quadrature amplitude modulation, 16QAM.

28. An apparatus comprising at least one processor, and at least one memory storing instructions that, when executed by the at least one processor, cause the apparatus at least to:
receive a modulation symbol from a transmitter;
compare the modulation symbol at least with an expected modulation symbol, wherein the expected modulation symbol is based on a pre-defined key; and
authenticate the transmitter based at least partly on the comparison.

29. The apparatus according to claim 28, wherein the comparison is based on an error vector magnitude between the received modulation symbol and the expected modulation symbol.

30. The apparatus according to claim 28, further being caused to:
receive a reference signal with a second modulation, wherein the modulation symbol is part of the reference signal;
read a modulation pattern of the reference signal;
compare the modulation pattern at least with an expected modulation pattern, wherein the expected modulation pattern is based on the pre-defined key; and
authenticate the transmitter based on the comparison.

31. The apparatus according to claim 28, further being caused to:
read the reference signal, while the reference signal is coded into the second modulation.

32. The apparatus according to claim 28, further being caused to:
convert the second modulation to a first modulation, wherein the second modulation comprises a higher modulation order than the first modulation; and
process the reference signal based on the first modulation.

33. An apparatus comprising:
means for generating a modulation symbol based on at least two bit sequences or at least two symbol sequences, wherein at least one sequence of the at least two bit sequences or the at least two symbol sequences is associated with a reference bit sequence or a reference symbol sequence, and at least one other sequence of the at least two bit sequences or the at least two symbol sequences is associated with a pre-defined key; and
means for transmitting the modulation symbol.

34. The apparatus according to claim 33, wherein the reference bit sequence or the reference symbol sequence is associated with at least one of the following: a Zadoff-Chu sequence, a positioning reference signal, or a sounding reference signal.

35. The apparatus according to claim 33, wherein the pre-defined key is associated with authentication information.

36. The apparatus according to claim 33, wherein the pre-defined key is known by an intended receiver of the modulation symbol.

37. The apparatus according to claim 33, wherein the modulation symbol is generated by providing the at least two bit sequences to at least one modulator, and applying a labelling for associating the modulation symbol with the at least two bit sequences.

38. The apparatus according to claim 33, further comprising:
means for changing, based on an indication received from a network node, the labelling for at least one of the following: the at least one modulator, or at least one other transmitted modulation symbol,
wherein the labelling is changed in a manner known by an intended receiver.
